(19) United States
(12) Patent Application Publication
(10) Pub. No.: US 2026/0116583 A1
(43) Pub. Date: Apr. 30, 2026

(54) Systems and Methods for Creating Structures In-Space

(71) Applicant: California Institute of Technology, Pasadena, CA (US)

(72) Inventors: Jongeun Suh, Pasadena, CA (US); Sahangi Dassanayake, Pasadena, CA (US); Sergio Pellegrino, Pasadena, CA (US)

(73) Assignee: California Institute of Technology, Pasadena, CA (US)

(21) Appl. No.: 18/900,559

(22) Filed: Sep. 27, 2024

Related U.S. Application Data
(60) Provisional application No. 63/540,726, filed on Sep. 27, 2023.

(51) Int. Cl. B64G 1/22; B64G 1/66; B64G 4/00; H01Q 1/28

(52) U.S. Cl. CPC B64G 1/2221; B64G 1/2228; B64G 1/66; B64G 4/00; B64G 2004/005; H01Q 1/288

(57) ABSTRACT

Devices for the assembly of structures are described. More specifically, devices designed for the assembly of structures in space are described, with a particular focus on antenna structures and methods for their assembly and deployment in space. Even more specifically, it addresses the construction of mesh reflector antennas in space. The invention includes devices, systems, and methods designed to facilitate the creation and deployment of these antennas in a space environment by leveraging advanced assembly techniques.

### CROSS REFERENCE TO RELATED APPLICATIONS

The current application claims the benefit of and priority under 35 U.S.C. 119 (e) to U.S. Provisional Patent Application No. 63/540,726 filed Sep. 27, 2023, the disclosure of which is incorporated herein by reference in its entirety.

### STATEMENT OF FEDERAL SUPPORT

This invention was made with government support under Grant No. HR0011-22-C-0054 awarded by DARPA. The government has certain rights in the invention.

### FIELD OF THE INVENTION

This application generally relates to space structures. More specifically, it relates to devices that can be utilized for the assembly of structures in space. Even more specifically, it relates to the assembly of mesh reflector antennas in spaces and devices that construct mesh reflector antennas in space, as well as systems and methods for their creation and use.

### BACKGROUND

In the field of space exploration and satellite technology, the development of deployable and constructible structures is a crucial area of research and innovation. These structures are designed to be compact during launch to maximize payload volumes and then expanded or assembled once in space. The size of a rocket's payload limits the size of devices that can be launched into space and subsequently affects the capabilities of any deployable device. One of the main advantages of deployable structures is their ability to make the most of the available space within the rocket payload, allowing for the launch of larger and more capable systems. By addressing the constraint of fitting within the limited volume of a rocket payload and maximizing the use of space and the size of the deployable structure, the efficiency of the launch and the devices that can be deployed is improved.

Deployable structures are engineered to unfold, expand, or be constructed from a compact state into a larger, functional form once they have been deployed into an in-space orbit from the rocket payload. Deployable structures are crucial for large antenna structures. Antenna structures form an essential component of space structures that are essential for communication with the Earth, and other structures conveying the data and information collected. For example, a deployable structure might be tightly folded or rolled up during launch, as illustrated in FIG. 1A. Once the rocket reaches the designated orbit and deploys the structure, the structure can then deploy its arrays and antennas through a series of mechanical as illustrated in FIG. 1B or inflatable mechanisms as illustrated in FIG. 2, achieving its full operational size. This process involves intricate engineering to ensure reliability and precision, as any malfunction could compromise the mission.

Constructible structures, on the other hand, involve the assembly of components in space. This approach can be likened to building a structure piece by piece, often using robotic systems or astronauts. Constructible structures offer the flexibility to create even larger and more complex systems than those possible with deployable designs alone. They are particularly useful for missions requiring large infrastructure such as scaffolds, trusses, antennas, or solar arrays. In the context of large antenna structures, constructible designs might involve launching multiple segments of an antenna separately and then assembling them in orbit. This method allows for the creation of antennas that are too large to be launched in a single piece, overcoming the size limitations imposed by rocket payloads.

The constraints of fitting structures within a rocket payload are significant. Rockets have limited space and weight capacities, which necessitate innovative design solutions to ensure that large structures can be launched efficiently. Engineers must consider factors such as the volume, weight, and deployment mechanism of the payload. The available space within the rocket's fairing (the protective shell that encases the payload) is limited, requiring structures to be compact and efficiently packed as illustrated in FIG. 1C). The total weight of the payload must be within the rocket's lifting capacity, influencing material choices and structural design and the mechanisms for deploying or assembling structures must be reliable and capable of functioning in the harsh environment of space. By addressing these constraints, deployable and constructible structures enable the deployment of large, sophisticated systems that enhance the capabilities of space missions. Large antenna structures, in particular, benefit from these technologies, allowing for improved communication, data collection, and scientific research from space.

### SUMMARY OF THE INVENTION

Devices and methods in accordance with some embodiments of the invention are directed to structure assembly devices and methods for their manufacture and use.

Many embodiments of the disclosure are directed to a large space structure assembly device comprising, an assembly structure configured to be deployed in space and proximal to a work volume, and having contained within the work volume an assembly module, an assembly sub-system, and having proximal to the work volume a plurality of joint elements, and a plurality of truss elements; wherein the assembly-sub system, the plurality of joint elements, and the plurality of truss elements, are disposed in an assembly area within the work volume; wherein the assembly module comprises a plurality of assembly coupling points and is configured to translate within a translation plane from a first position wherein a first portion of the assembly module having at least a first coupling point is located in the assembly area and a second position wherein a second portion of the assembly module is located outside of the work volume in a deployment area; wherein the assembly sub-system further comprises a manipulator configured to translate and rotate within an assembly plane parallel to the translation plane and wherein the manipulator is configured to actuate perpendicular to the assembly plane and selectively couple with and transfer the joint elements and truss elements from a storage position to an assembly coupling point such that each joint element is coupled to the assembly module at an assembly coupling point and such that each truss element is interconnected between two joint elements; wherein the manipulator is configured to interconnect at least one truss element and at least one joint element on the assembly module to form a truss bay, and wherein the manipulator and assembly module are configured to operate together to sequentially form a plurality of truss bays wherein at least one joint of each adjacent truss bay pivotally couples two truss bays; and wherein when a truss bay is assembled on the assembly module and the assembly module translates from the first position to the second position, any pivotally coupled truss bay disposed in the transfer area is moved into the deployment area.

In some embodiments the device further comprises a transfer element disposed in a transfer area and comprises a transfer coupling element that is disposed within a transfer plane.

In some embodiments the assembly module further comprises a second portion having at least a second coupling point that at the first position is located in the transfer area at the transfer plane, and at the second position, is located outside of the work volume.

In some embodiments the first coupling point is located in the transfer area at the transfer plane at the second position

In some embodiments the transfer element is configured to selectively couple with the truss bay when the assembly module is located at the second position and transfer the truss bay off the assembly module to a transfer position and transfer the truss bay from the transfer position to the assembly module when the assembly module is located in the first position.

In some embodiments the device further comprises a storage sub-system configured to store at least one assembly component selected from the group consisting of the plurality of truss elements and the plurality of joint elements.

In some embodiments the storage sub-system is configured to present each of the at least one assembly component to the manipulator.

In some embodiments the plurality of pivotally coupled subsequent truss bays within the deployment area are configured as a configuration selected from the group consisting of perimeter truss structure, triangular truss structure, parallel truss structure, tubular structure, flat plate structure and scaffolding structure.

In some embodiments a first end of the configuration is coupled to the structure.

In some embodiments the device further comprises a preassembled bay coupled to the structure at a first end.

In some embodiments the structure is configured with a first configuration with a first volume for transportation and a second configuration with a second volume for operation.

In some embodiments the transfer element is configured to selectively couple with the joint element and transfer the joint element from a first point on the assembly module to a second point on the assembly module.

In some embodiments the transfer element comprises an electromagnet.

In some embodiments each of the plurality of joint elements comprises a plurality of plates and a shaft wherein each plate is coupled to the shaft and configured to rotate about the shaft.

In some embodiments each plate is further configured with a reception area configured with a geometry complementary to the truss element. In some embodiments at least one of the interconnected truss element and joint element further comprises an interconnecting element selected from the group consisting of a magnet, an electromagnet, a clamp, an actuator, a gripper, a latch, a compression fitting, and a compliment structure that couples and interconnects the truss element and the joint element.

In some embodiments the joint element further comprises a spring element configured to provide rotational stiffness.

In some embodiments each of the assembly coupling points further comprises an assembly point coupling element configured to selectively couple with the plurality of joint elements selected from the group consisting of a magnet, an electromagnet, a clamp, an actuator, a gripper, a latch, a compression fitting, and a compliment structure.

In some embodiments the storage sub-system is configured to rotate to present a selected assembly component to the manipulator.

In some embodiments the device further comprises an internal structure configured to couple to the plurality of joints.

In some embodiments the internal structure is a net.

In some embodiments the device further comprises a cable coupled to the structure and a cable retraction device configured to tension the cable.

In some embodiments each of the plurality of truss elements is configured to be stored in a first configuration and modified to a second configuration for operation.

Many embodiments of the disclosure are directed to a method of large space structure assembly comprising: deploying a plurality of independent joint elements and a plurality of independent truss elements into space within an assembly satellite proximal to a work volume; interconnecting at least one truss element through at least one joint element to form a truss bay within the work volume; extending the truss bay outside of the work volume; and repeating the interconnecting of truss elements and joint elements to sequentially form a plurality of truss bays, wherein each truss bay is interconnected to an adjacent truss bay such that a plurality of interconnected truss bays are formed and sequentially extended outside of the work volume as a single space structure.

In some embodiments the interconnecting comprises: positioning at least one joint element on an assembly module with a manipulator; and coupling at least one truss element to the at least one joint element with the manipulator to form a truss bay.

In some embodiments extending the interconnected truss bays outside of the work volume comprises: sequentially transferring each of the plurality of truss bays from a first point on the assembly module to a transfer element when the assembly module is in the second position; sequentially transferring each of the plurality of truss bays from the transfer element to a second point on the assembly module when the assembly module is in the first position; and assembling the plurality of truss bays into a perimeter truss structure.

In some embodiments assembling the truss bay further comprises coupling at least one truss element to a joint of a preassemble truss bay disposed within the work volume and coupled to the assembly satellite at a first end.

In some embodiments the preassembled truss bay is coupled to the assembly satellite through a cable through a retraction device configured to retract the cable to keep a predefined tension thereon.

In some embodiments the method further comprises coupling an internal structure to each of the plurality of truss bays.

In some embodiments the method further comprises tensioning the perimeter truss structure with a set tension to manipulate the single space structure into an orientation.

In some embodiments the joint elements and truss elements are configured to couple with magnets.

In some embodiments the assembly module comprises an assembly coupling element configured to selectively couple with the plurality of joints.

In some embodiments the transfer element comprises a transfer coupling element configured to selectively couple with a truss bay.

In some embodiments, the manipulator comprises a manipulator coupling element configured to selectively couple with the plurality of joint elements and the plurality of truss elements.

Many embodiments of the disclosure are directed to a system for assembling large space structures comprising: an assembly unit configured to be deployed in space and proximal to a work volume, and having disposed proximal to the work volume a plurality of individual and disconnected truss elements and a plurality of individual and disconnected joint elements; wherein the assembly unit is configured to selectively interconnect the plurality of the individual and disconnected truss elements through the plurality of the individual and disconnected joints to form at least two interconnected truss bays, each truss bay being formed by at least one truss element and one joint element; and wherein the assembly unit is further configured to extend the interconnected truss bays outside of the work volume as a single space structure.

In some embodiments a disconnected internal structure is disposed proximal to the work volume, and the assembly unit is further configured to couple the internal structure to the interconnected truss elements so the internal structure spans the single space structure.

In some embodiments the single space structure is configured as a reflector antenna.

In some embodiments the assembly unit is further configured to apply a first tension to the internal structure to facilitate the extension of the interconnected truss elements.

In some embodiments the assembly unit is further configured to apply a second tension to the internal structure and articulate the single space structure into a configuration.

In some embodiments the assembly unit is further configured to extend the interconnected truss elements outside the work volume at a selected angle.

In some embodiments the truss bays are configured with a plurality of geometries such that when the interconnected structure is extended, the single space structure forms a set configuration.

In some embodiments the assembly unit is further configured to apply a force to the interconnected truss bays such that the interconnected truss bays outside the work volume translate to a selected orientation.

In some embodiments the assembly unit is configured to be transported to space in a first configuration and, when deployed in space, articulate to a second configuration for operation.

In some embodiments the assembly unit is configured to extend the interconnected truss elements outside the work volume sequentially as each is constructed.

In some embodiments at least two of the interconnected truss elements are connected at one end to the assembly unit such that the assembly unit forms a section of the single space structure.

Additional embodiments and features are set forth in part in the description that follows and, in part, will become apparent to those skilled in the art upon examination of the specification or may be learned by the practice of the disclosure. A further understanding of the nature and advantages of the present disclosure may be realized by reference to the remaining portions of the specification and the drawings, which form a part of this disclosure.

### BRIEF DESCRIPTION OF THE DRAWINGS

The description will be more fully understood with reference to the following figures, which are presented as embodiments of the invention and should not be construed as a complete recitation of the scope of the invention wherein:

FIGS. 1A through 1C provide illustrations of structures for deployment in space in accordance with aspects of the prior art.

FIG. 2 provides an illustration of an inflatable structures for deployment in space in accordance with aspects of the prior art.

FIG. 3 provides illustrations of an AstroMesh architecture in accordance with aspects of the prior art.

FIGS. 4A and 4B provide schematic illustrations of a circular paraboloid surface and cable net configuration, in accordance with some embodiments.

FIGS. 5A through 5C provide data graphs plotting the availability of rocket launchers for mesh reflectors with large apertures in accordance with some with some embodiments.

FIG. 6 provides a schematic illustration of an ISA design of the reflector in accordance with some embodiments.

FIGS. 7A through 7C provide data graphs plotting the launch limitation corresponding to an in-space assembled reflectors in accordance with various embodiments.

FIG. 8 provides a schematic illustration of an in-space assembly facility (truss builder) in accordance with several embodiments.

FIGS. 9A through 9C provide schematic illustrations showing the deployment of assembled bays forming a perimeter in accordance with some embodiments.

FIG. 10 provides a schematic illustration of joints and hinge elements in accordance with some embodiments.

FIG. 11 provides a schematic illustration of a truss element in accordance with many embodiments.

FIGS. 12A and 12B provide schematic illustrations of the connection between a hinge element and a truss element in accordance with some embodiments.

FIGS. 13A through 13E provide schematic illustrations of an exemplary truss builder in accordance with some embodiments.

FIG. 14 provides a flow chart of the assembly process in accordance with some embodiments.

FIGS. 15A through 15C provide schematic illustrations of a reflector assembly operation with a tilted plate truss in accordance with some embodiments.

FIGS. 16A and 16B an image of a latching force measurement setup and a data table reporting the latching force in accordance with some embodiments.

FIG. 17 provides a schematic illustration of the magnetic force interactions between electromagnets and the permanent magnet in accordance with some embodiments.

FIG. 18A provides a schematic illustration of design parameters for magnet interactions in accordance with some embodiments.

FIGS. 18B through 18F provide data graphs of the variation of the design parameters sensitivity analysis results for electromagnets and permanent magnets in accordance with some embodiments.

FIG. 19A provides a schematic illustration of a corner of a reflector assembly in accordance with some embodiments.

FIG. 19B provides a schematic illustration of a constructed bay behind the assembly module axis in accordance with some embodiments.

FIGS. 20A and 20B provide schematic illustrations of truss builders designed to release the constructed at different angles in accordance with some embodiments.

FIGS. 21A and 21B provide schematic illustrations and data results of the relationship between the plate angle and the interior angle of the assembled truss in accordance with some embodiments.

FIGS. 22A through 22C provide schematic illustrations of the cable net configuration in accordance with some embodiment.

FIGS. 23A and 23B provide schematic illustrations for a 12-bay structures in accordance with exemplary embodiments.

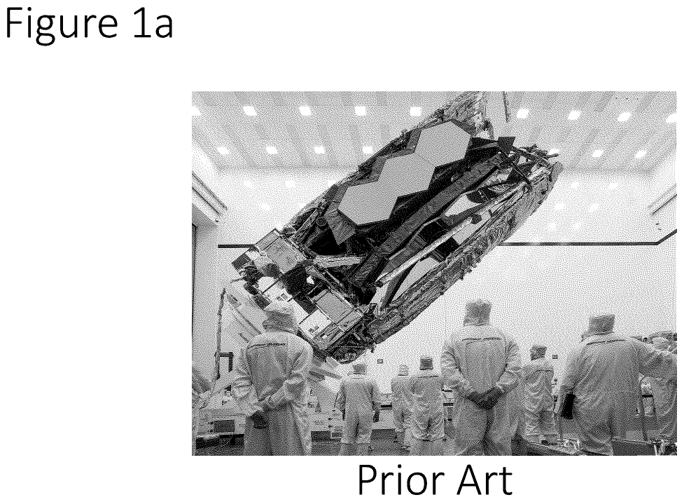

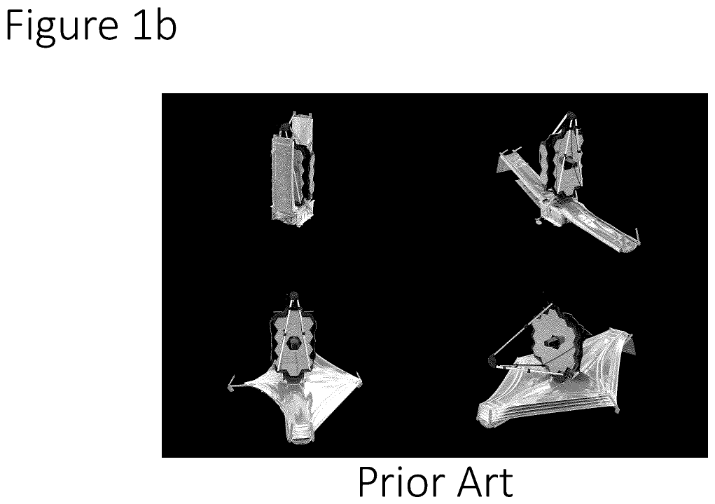

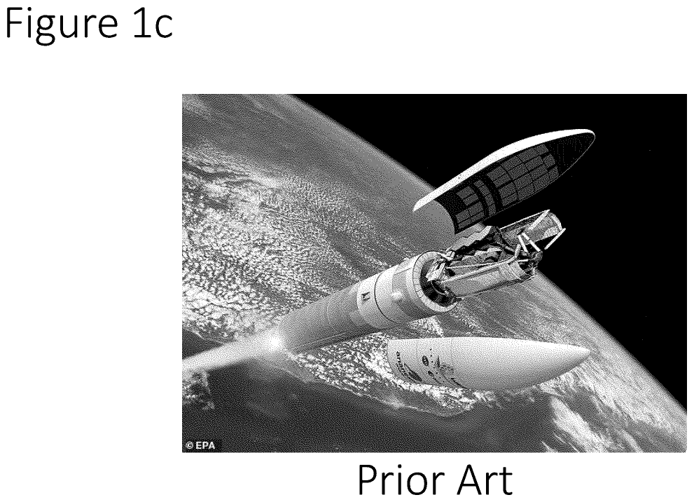

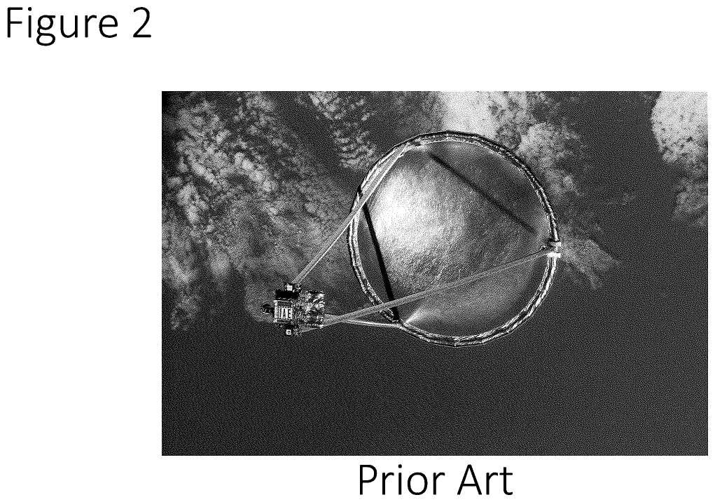

### DETAILED DESCRIPTION OF THE INVENTION

It will be understood that the components of the embodiments, as generally described herein and illustrated in the appended figures, may be arranged and designed in a variety of different configurations. Thus, the following more detailed description of various embodiments, as represented in the figures, is not intended to limit the scope of the present disclosure but is merely representative of various embodiments. While various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages and similar language throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may but do not necessarily, all refer to the same embodiment.

The construction of large structures in space is important to facilitate more advanced space missions. The size of the launch fairing restricts traditional deployable designs. The growing demand for more advanced and complex space missions necessitates larger space structures. Deployable designs have been considered the standard approach for large space structures in space and utilized for space missions with sizes ranging from 10 to 20 meters. However, the size of the structures built to with deployable designs is generally restricted by the mass and volume constraints of the launch vehicle. Deployable architectures have to meet the mass and volume constraints of launch vehicles, as well as the load constraints imposed by the dynamic environment during the launch. It is typically not feasible to launch structures with stowed heights greater than 20 m with existing launch vehicles. This leads to the need for In-space assembly (ISA) for building extremely large structures. Payloads that do not fit in the launcher's faring require a different strategy; the components of the structures are separately packaged, delivered to the target orbit, and assembled in space to complete its functional configuration.

In-space assembly (ISA) architecture requires particular consideration of several key design aspects. First, the structural components need to be modularly designed for simple assembly and integration. Second, the stiffness of the assembled structure needs to be considered to ensure it is adequate to support itself at the various stages of assembly. Additionally, the assembly operation and complexity need to be considered. Ideally, the assembly should be autonomous, and therefore, the employment of robotic devices and automation is essential.

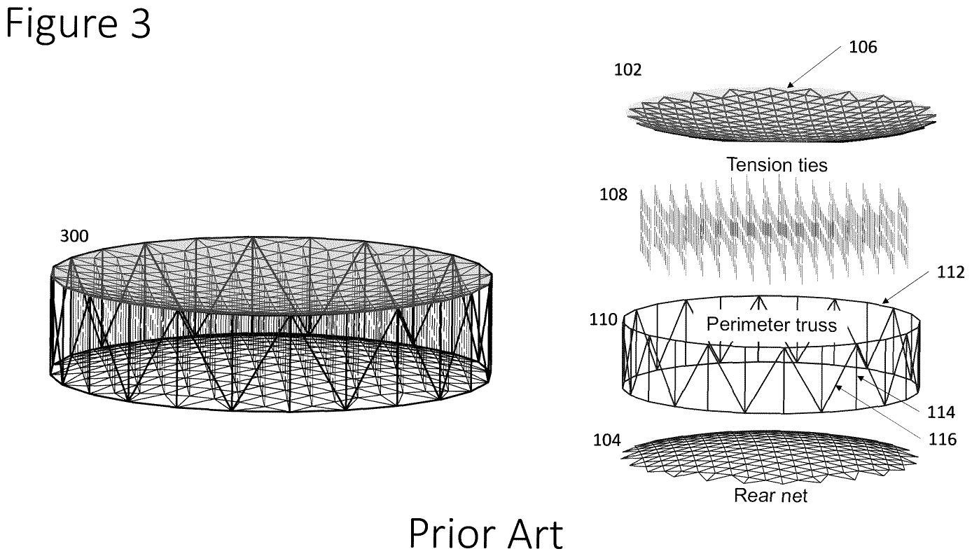

A typical deployable architecture is the AstroMesh, which is illustrated in FIG. 3. An AstroMesh structure 300, consists of double curved cable nets 302 and 304 connected by tension ties 308 and supported by a deployable perimeter truss 310 constructed of Longerons 312 (horizontal elements), Battens 314 (vertical elements) and Diagonal elements 316. A reflective metallic layer 306 is attached to one of the cable nets 302.

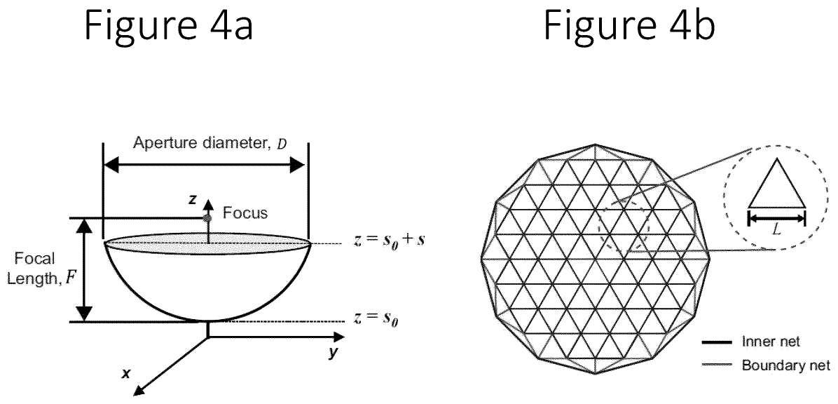

The utilization of AstroMesh reflector style architecture designs has been successfully deployed to achieve mass and volume efficiency. The reflective surface is typically designed to be parabolic to maximize the antenna's directivity. FIG. 4A shows a circular paraboloid surface with diameter D, focal length F, apex height s0, and rim height s0+s. One of the critical design parameters affecting the geometry of the parabolic reflector is its FID ratio; the higher FID ratio, the shallower the paraboloid surface. The smooth reflecting surface is approximated by triangular facets of size L, forming a triangular tessellation, as shown in FIG. 4B. Faceting of the paraboloid surface introduces a surface deviation error related to the size of the triangles. Therefore, L is determined by considering the surface RMS error requirement. The faceting error of a spherical surface with radius R is:

$$δ = \frac{{L}^{2}}{8 \sqrt{15} R}$$

Any given axisymmetric paraboloid can be approximated by a spherical cap, and the following relationship between R and the design parameters of the paraboloid is used to calculate the facet size:

$$R = 2 F + \frac{{D}^{2}}{32 F}$$

The maximum allowable size of the facet increases proportionally to VD as the diameter of the reflector increases. Once the facet size is determined for a reflector of the required size, the number of subdivisions of the reflective surface, n, is calculated using the relationship: n=0.5 D/L.

The mass and stowed volume of this deployable mesh reflector depend on the F/D ratio and vary as a function of the prestress magnitude and its distribution. Once the prestress distribution has been obtained for any chosen F and D, the perimeter truss can be sized, and its mass can be estimated. Then, the total mass of the reflector, M, can be obtained from the sum of the mass of the cable nets, mc, the metallic mesh, mm, and the tension ties, mtt, which can be assumed to have a constant area density, to the mass of the perimeter truss, mt, and its joints, mj, which is related to the specific F and D, and the deployment actuators whose mass, ma, is assumed to be linearly dependent on D. Therefore:

$$M = {m}_{c} + {m}_{m} + {m}_{tt} + {m}_{t} + {m}_{j} + {m}_{a}$$

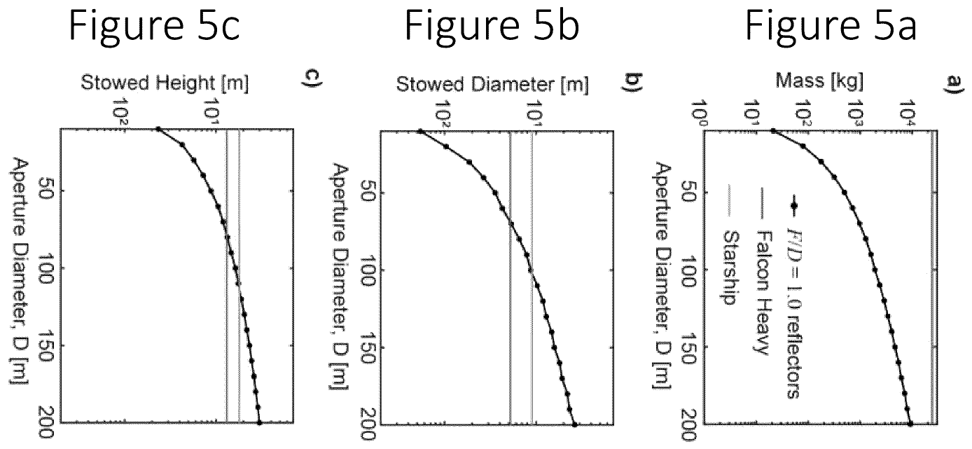

The diameter and height of the stowed perimeter truss can be estimated from the length and diameter of its tubular members, which are assumed to have reached the nearest possible distance allowed by the joints. The variation of total mass, stowed diameter, and height are shown in FIGS. 5A through 5C for the diameter range 10 m to 200 m. The figure shows that the total mass and stowed volume of the mesh reflector scale exponentially with increasing diameter. The availability of rocket launchers for mesh reflectors with large apertures is illustrated by the lines in FIGS. 5A through 5C, representing the payload limits for the Falcon Heavy and Starship launchers. The figure shows that, although the deployable antenna design lies well within the limit for maximum payload mass to geostationary transfer orbit (GTO), the achievable aperture size is restricted to 100 m by the volume of the fairing of these launch vehicles. In order to achieve larger structures and apertures new designs and building strategies are needed to overcome the geometric constraints imposed by the launch vehicles.

### Embodiments

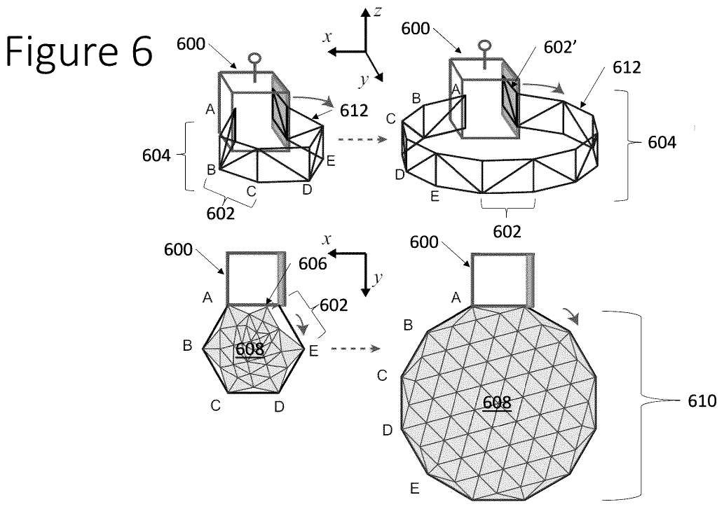

A schematic of an ISA design of the reflector that is similar to the deployable Astromesh reflector is depicted in FIG. 6. Instead of deploying from a stowed configuration, many embodiments of the invention assemble and build the reflector in space. In many embodiments, the components of the reflector are designed to be modular and are packaged inside an assembly facility (truss builder) 600. In many embodiments once the truss builder 600 arrives at the target orbit, it starts assembling the reflector with repetitive operations. In many such embodiments, the truss builder 600 assembles a single bay 602 of the perimeter truss 604 and connects the corresponding node 606 of the folded cable net 608 to the constructed bay 602. The truss builder 600 constructs a new bay 602′ connecting the new bay 602′ to the previous bay 602 in the perimeter truss 604 and releases the assembled bay 602; the reflector assembly 610 is complete once the last bay 602 is released by the truss builder 600.

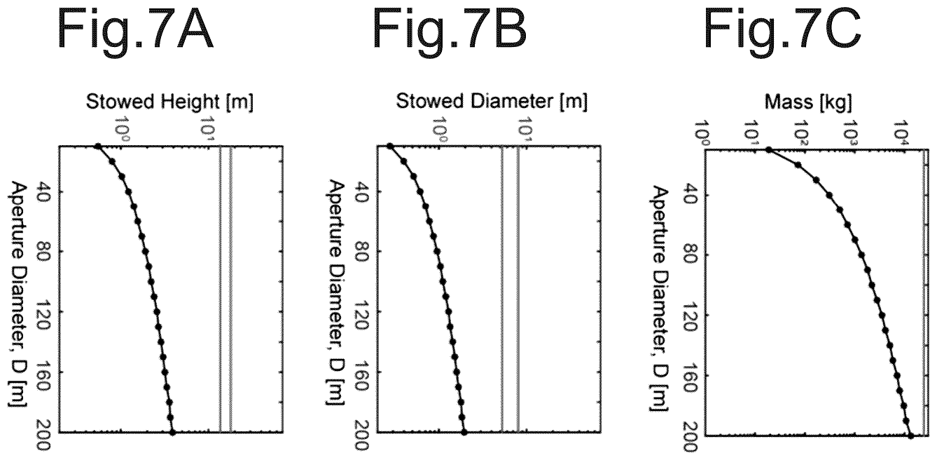

For many embodiments of the invention, limitations corresponding to an in-space assembled reflectors can be derived based on a structure and assembly concept similar to an AstroMesh, as illustrated in FIG. 7. In such embodiments, both front and rear nets are fabricated and assembled with tension ties and metallic mesh like the AstroMesh structure. The net assembly is stowed in the truss builder 600 and the stowed volume of the net assembly 608 is assumed to be 20 times its material volume. The truss elements 612 for the perimeter truss 604 are stowed in a flattened and coiled configuration. The coiling mandrel's dimension is calculated as: the height of the mandrel is the same as the flattened width of the truss element 612, and the mandrel diameter is chosen to be equal to the height. The maximum diameter of the mandrel plus coiled truss element is set to four times the mandrel diameter. Then, the total number of spools is calculated by considering the total length of truss elements. The volume of the joint stack is calculated from the envelope of the joint. Once the total volume of the stowed components is obtained, the stowed diameter and height of the components are derived by assuming that all the components are stored inside a cylindrical envelope with a height of twice the diameter. The results are illustrated in FIGS. 7A though 7C with lines representing the payload limits for the Falcon Heavy and Starship launchers.

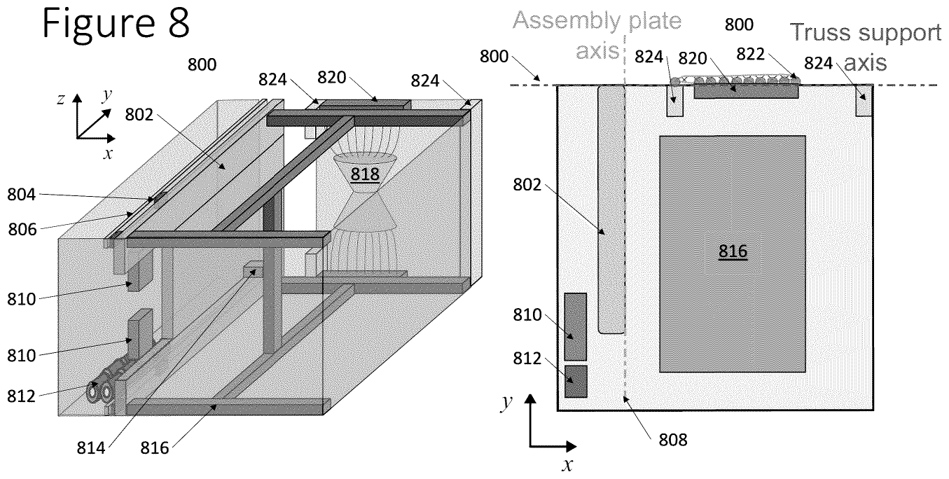

FIG. 8 shows schematics of the in-space assembly facility (truss builder) 800 in accordance with several embodiments. In many embodiments, the truss builder 800 comprises several robotic subsystems configured for the bay construction, deployment and release. In many such embodiments, the truss builder constructs bays for the perimeter truss on an assembly module 802. The assembly module 802 is configured to articulate and slide in and out of the truss builder 800 to release each constructed bay. In many embodiments, assembly module 802 is configured to couple to the truss builder 800 with liner guide blocks 804 that are coupled to liner guide rails 806 that are configured so that the assembly module 802 can articulate along an assembly module axis 808 to position the module for assembly and deployment of truss bays. In many embodiments, the truss builder 800 is further configured with joint dispensers 810 and truss element dispensers 812. In some such embodiment the joint 810 and truss element dispensers 812 are disposed behind the assembly module 802. The joint 810 and truss element dispensers 812 contain the joint and truss element modules that are configured to couple with a manipulator 814 of an assembly sub-system 816 for assembling truss bays. In some embodiments, the manipulator 812 and assembly sub-system 816 for the bay construction are configured as a gantry system. In many such embodiments, the gantry system is configured with the manipulator 814 to enable three translational motions and one rotational motion for picking up and connecting the components. In many such embodiments, the gantry system is configured to translate in x, y, and z planes, and the manipulator 812 is configured to rotate about an axis. While a cartesian gantry system is utilized by the exemplary assembly sub-system 816, other embodiments utilize any number of movement configurations that would be known to someone skilled in the art; for example, delta systems. In many embodiments, a folded net 818 is stowed in a net storage system 820. In many such embodiments, the net storage system is disposed near the exit where the assembly module 802 translates along the assembly module axis 808 of the truss builder. In many embodiments, the net joints are coupled with net coupling devices 822. In many embodiments, the truss builder 800 is further configured with truss support elements 824, where the ends of the perimeter truss are attached during assembly. The following subsections provide more details on the design of the truss builder.

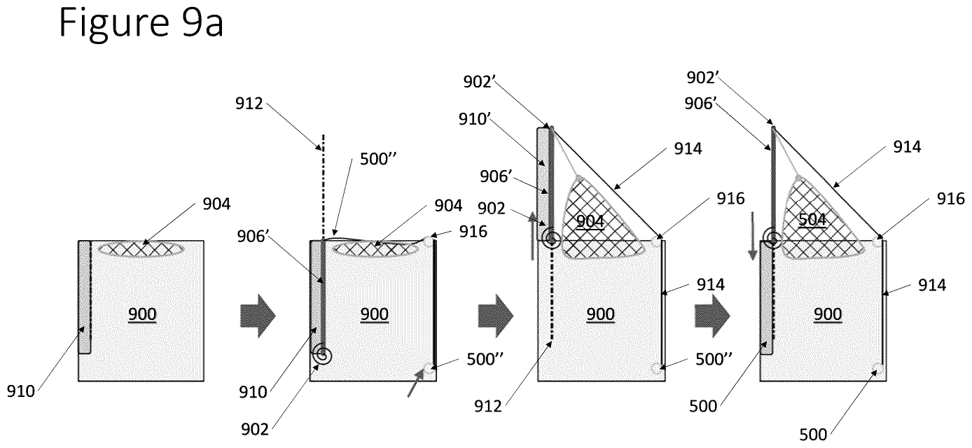

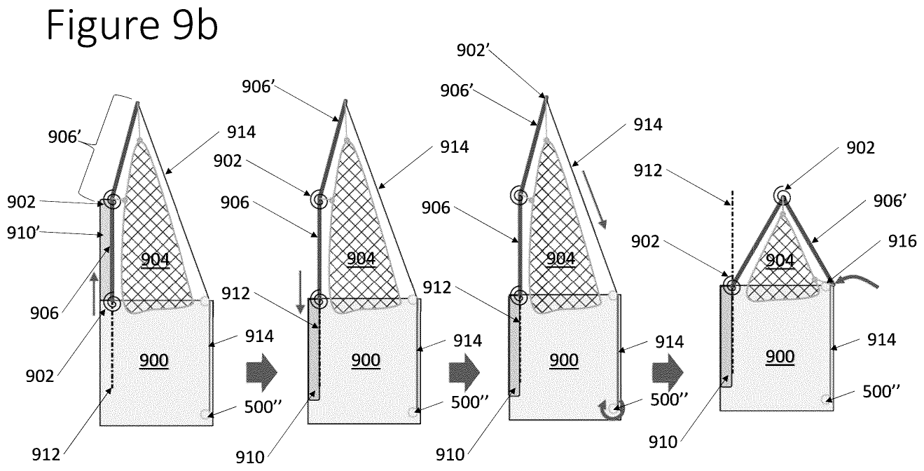

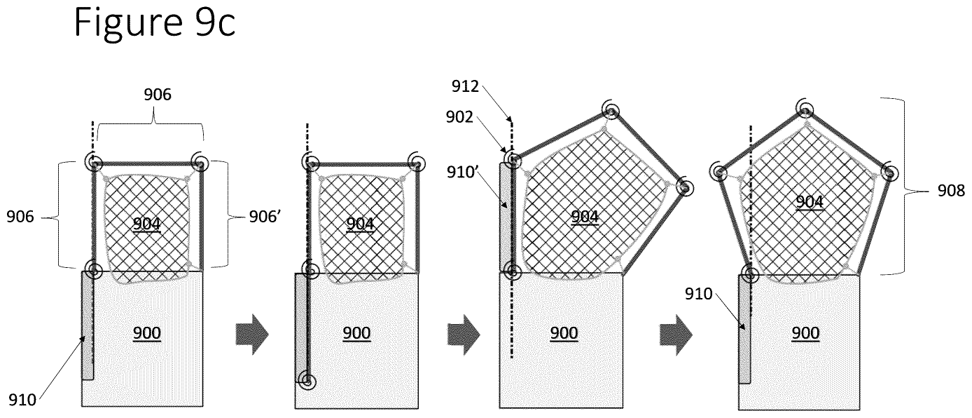

FIGS. 9A through 9C depict schematics showing the deployment of assembled bays forming the perimeter truss and constructing an antenna reflector structure in accordance with some embodiments of the disclosure. In many embodiments, the assembly facility 900 is folded and stowed in the launch vehicle. The components of the reflector (i.e., truss elements, joints 902, and nets 904) are stowed inside the truss builder. Once the truss builder is placed in its target orbit, it is expanded for assembly. In many embodiments, the bays 906 of the perimeter truss 908 are assembled inside the truss builder 900 on an assembly module 910. The assembly module 910 translates along an assembly module axis 912 locating the assembly module 910′ and constructed bay 906′ outside of the assembly facility 900. The assembled bays 906 are pushed out of the truss builder 900 sequentially, as illustrated in FIG. 9B, increasing the diameter of the perimeter truss 908 as more bays 906 are added. In many embodiments, the cable nets 904 are attached to the joints 902 of the perimeter truss 908 as each bay 906 is released.

In many embodiments, the first bay 906 of the perimeter truss 908 is coupled to a cable 914. In many such embodiments, the cable 914 is coupled to the foremost joint 902′ of first bay 906. Once a subsequent bay 906 has been released, this cable 914 is retracted to bring the first joint 902′ proximal to coupling point 916 on the truss builder 900. In many embodiments the cable 914 is retracted by a retraction device 918 such as a motor or spring. After the cable 914 is retracted the first joint 902′ is coupled to coupling point 916 of the truss builder 900. The bay construction process is then repeated until the perimeter truss 908 has been completed. In many embodiments, to ensure the stability of the structure during the assembly process, the joints 902 are configured to be elastically deformable to maintain a circular shape for the constructed bays 906.

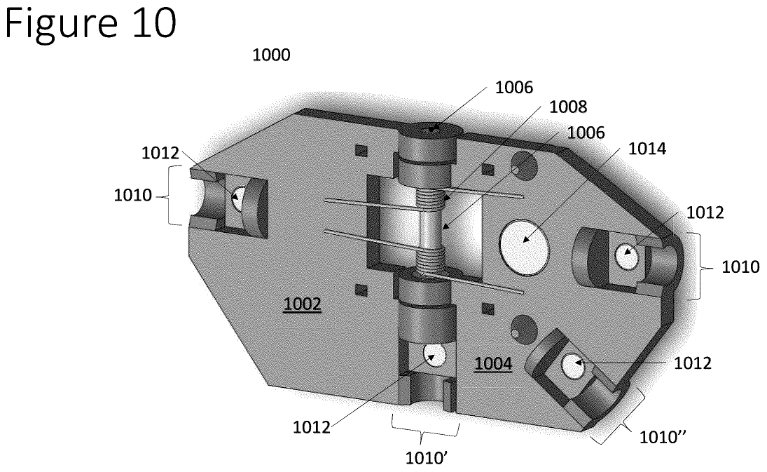

In many embodiments, the joints 902 are configured as hinge elements, as illustrated in FIG. 10. In many embodiments, the hinge elements 1000 are configured with multiple plate elements 1002 and 1004. In many embodiments, the plate elements 1002 and 1004 are configured with bearings coupled to a shaft 1006 to enable the rotational motion relative to each other. In many embodiments, torsional springs 1008 are mounted along the shaft 1006 and are configured to provide rotational stiffness. In many embodiments, the hinge element is configured with truss element reception areas 1010. In many such embodiments, there are four struct reception areas 1010 configured to receive the longeron 1010, batten 1010′, and diagonal 1010″ truss elements. In many embodiments, each truss element reception area 1010 is configured with a magnet 1012, which holds a truss element in place during the assembly process. In many embodiments, the hinge elements 1000 comprise manipulator magnets 1014 configured so that the manipulator 814 can couple to, manipulate, and position the hinge elements 1000. In some embodiments, the manipulator magnets 1014 are configured to couple the hinge elements 1000 to the assembly module 802 for the construction of truss bays.

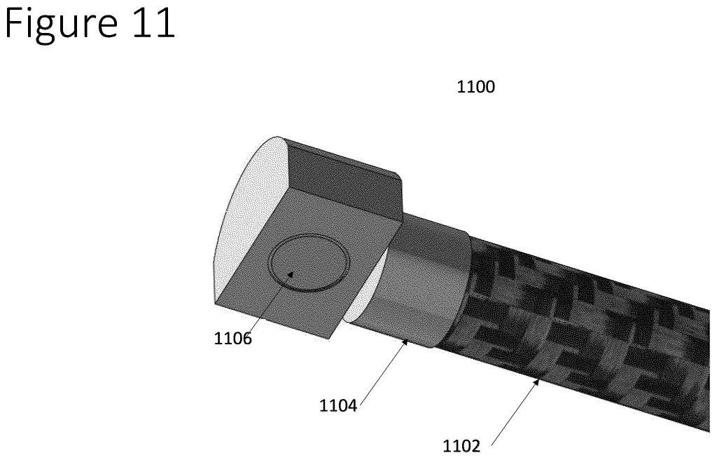

FIG. 11 illustrates a truss element in accordance with many embodiments. In many embodiments, the truss elements 1100 (longeron, batten, and diagonal) comprise shafts 1102 with endcaps 1104. In many embodiments, the endcaps 1104 comprise complementary magnets 1106 configured to couple with the hinge element magnets. In some embodiments, the shafts 1102 are solid or hollow tubes. In other embodiments, the shaft 1102 is stowed as compressed elements that expand into a deployable configuration. In some embodiments, the truss elements 1102 are struts, tubes, expandable coils, inflatable members, hollow beams, solid beams, box beam or beams of other cross-sectional geometries that would be known to one skilled in the art. In some embodiments, the truss elements are pultruded carbon-fiber composite tubes. In many embodiments the truss elements are made from material that would be known to one skill in the art for deployment in space. In many embodiments, the endcap cap is configured to complement the shape of the struct reception areas 1010.

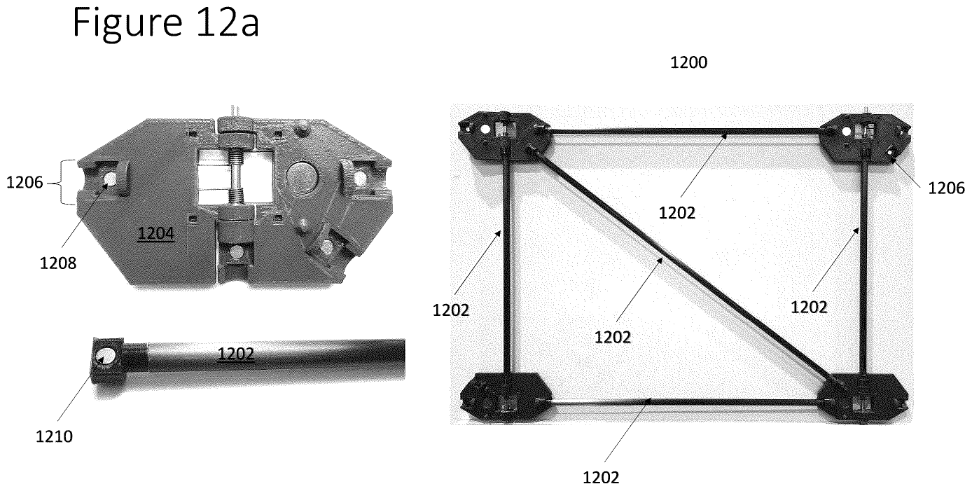

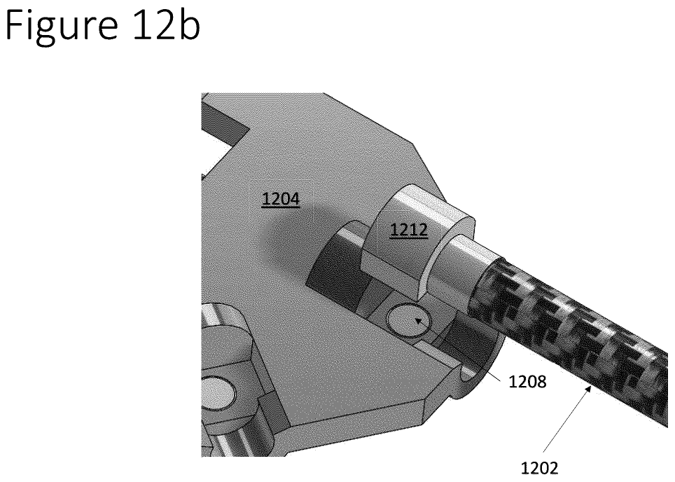

The connection between a hinge element and a truss element are illustrated in FIGS. 12A and 12B. Truss bays 1200 are constructed of multiple truss elements 1202 coupled to hinge elements 1204. The truss elements 1202 are disposed in the truss reception areas 1206 and coupled to the hinge elements 1204. In many embodiments, complementary hinge element magnets 1208 and truss element magnets 1210 couple the truss 1202 and hinge elements 1204 to form truss bays 1200. In some embodiments, the truss endcap 1212 is configured to be friction or press fit into to truss reception area 1206 to couple the truss element 1202 and the hinge element 1204.

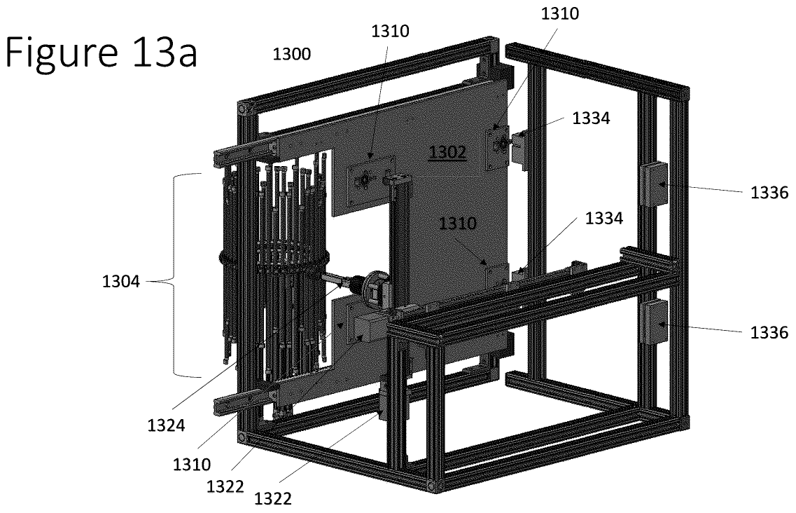

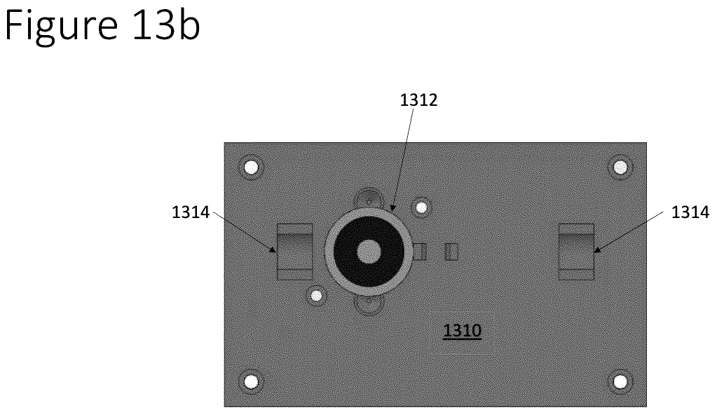

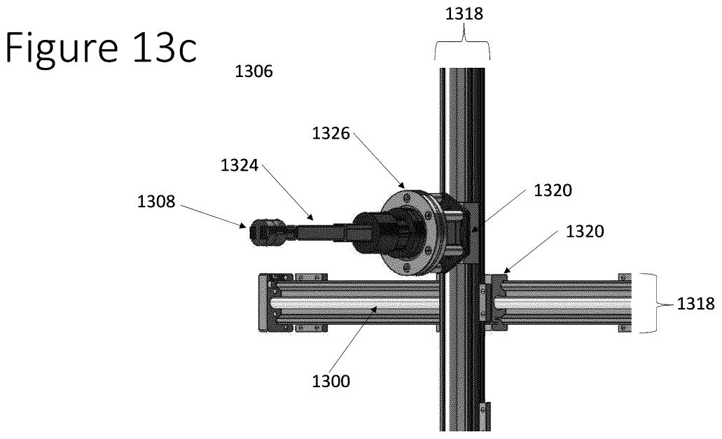

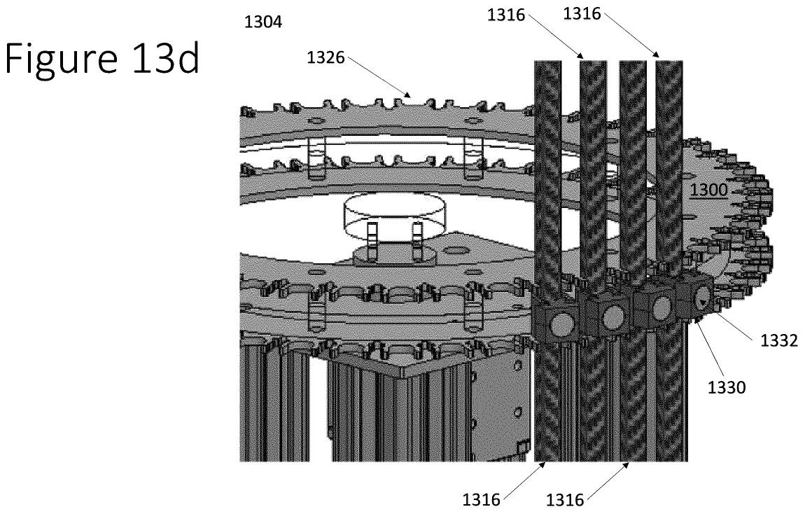

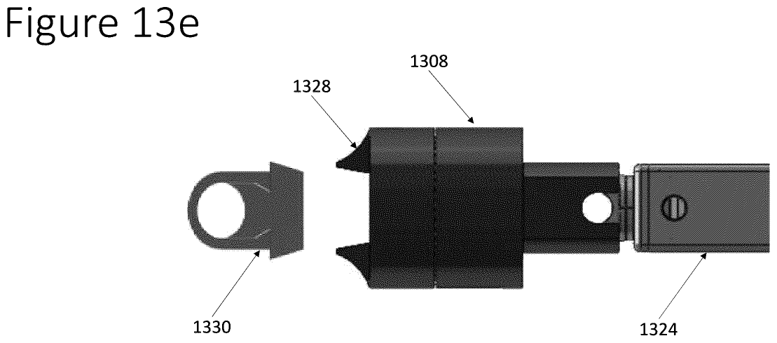

An exemplary truss builder is illustrated in FIGS. 13A through 13E. The truss builder 1300 is composed of the sliding assembly module 1302, truss storage sub-system 1304, and assembly sub-system 1306 and manipulator 1308. The assembly module 1302 is configured with joint mounting plates 1310. In many embodiments each joint mounting plates 1310 comprises an electromagnet 1312. In many such embodiments, each joint contains a permanent magnet, and during the bay construction, the electromagnet 1312 holds the joint on the joint mounting plate 1310. In many embodiments, the joint mounting plates 1312 further comprise supports 1314 configured to receive the truss elements 1316. In many embodiments, the manipulator 1308 picks up the truss elements 1316 and joints from the storage sub-system 1304 and places them in the desired location on the assembly module 1302 to build a truss bay; In many embodiments, placement of the joints and truss elements 1316 requires a 4-DoF (x, y, and z translational, and Rz rotational direction) capable manipulator 1308. In many embodiments, the manipulator 1308 is disposed on the assembly sub-system 1306. In some embodiments, the assembly sub-system 1306 consists of linear tracks 1318 and stages 1320 (for x and y) translated by translation motors 1322. In many embodiments, the manipulator 1308 comprises a push-actuator 1324 for z. In many such embodiments, the manipulator 1308 comprises a bearing 1326 and a motor for Rz. In many embodiments, the push actuator 1324 is installed on the motor, and the push actuator-motor assembly is coupled to the linear stages 1320.

In many embodiments, the storage sub-assembly 1304 holds truss elements 1316 along its perimeter in truss element storage areas 1326. In many embodiments, a truss element retaining element is mounted and disposed on the manipulator 1328 that is complementary to the shape of the truss element 1316. In some embodiments, the truss element 1316 further comprises a sleeve element 1330. In some embodiments, the manipulator 1308 further comprises an electromagnet configured to couple with a magnet 1332 disposed in sleeve element 1330. In many embodiments, once the manipulator 1308 picks up a truss element 1316, the storage subassembly 1304 rotates to present another truss element 1316 to manipulator 1308. In many embodiments, an electromagnet on the tip of the manipulator 1308 interacts with the sleeve magnet 1332 to hold and release the truss element 1316 during bay construction. In many embodiments, the geometry of the sleeve 1330 complements the truss retaining element 1328.

In many embodiments transfer elements 1334 are disposed proximal to the exit of the truss builder. In many embodiments, the transfer elements 1334 comprise electromagnets. In many embodiments, the transfer elements selectively couple, hold and release the truss bay. In many embodiments, the transfer elements secure the truss bay when released by the assembly module 1302. In some embodiments, the transfer element 1334 articulates and retracts the truss bay away from the assembly module 1302. In some such embodiments, the retraction provides clearance for the assembly module 1302 to retract. In some embodiment, the first truss bay is preconstructed, and the distal end of the truss bar is coupled to the truss builder 1300 at coupling points 1336.

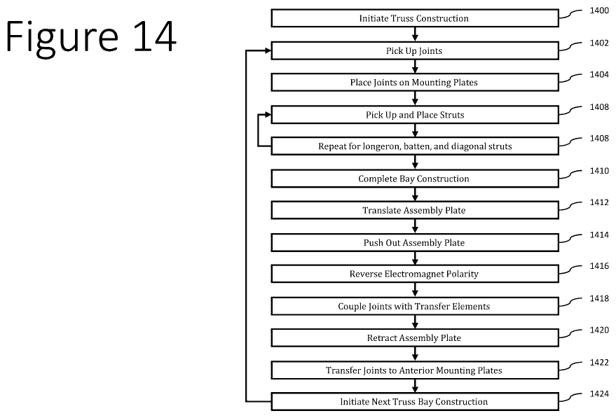

In some embodiments, the assembly process involves the sequential operation depicted in the flow chart shown in FIG. 14. In an exemplary truss bay construction and release, first at step 1400, the truss construction is initiated. At step 1402, the manipulator picks up joints. Each joint contains a permanent magnet in its body, and during the bay construction, an electromagnetic force holds the joints at the right locations. At step 1404, the manipulator places the joints on the mounting plates. At step 1406, the manipulator picks up a truss element from the storage subassembly and places it between corresponding joints. At step 1408 step 1406 is repeated for the subsequent truss elements (longeron, batten, and diagonal). At step 1410, the bay is completed after all the truss elements have been placed. At step 1412, the assembly module translates, relocating the completed truss bay. At step 1414, the assembly module is fully pushed out of the truss builder, and the posterior joints are aligned with the transfer elements. At step 1416, the polarity of the electromagnets on the mounting plates is reversed, and the joints decouple from the mounting plate. At step 1418, the electromagnets in the transfer elements couple the joint transferring the truss bay. At step 1420 the assembly module translates and retracts inside the truss builder. At step 1422, the polarity of the two electromagnets on the transfer elements is reversed, and the joints are transferred to the anterior mounting plates. At step 1424, the next truss bay construction is initiated.

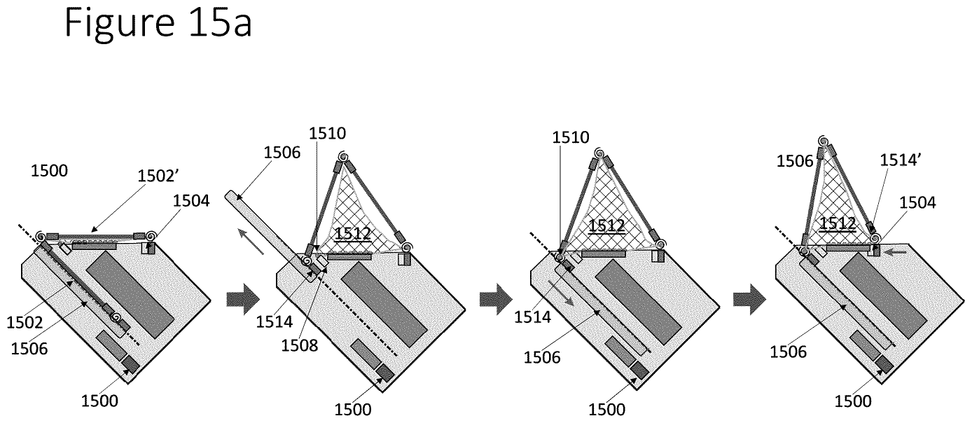

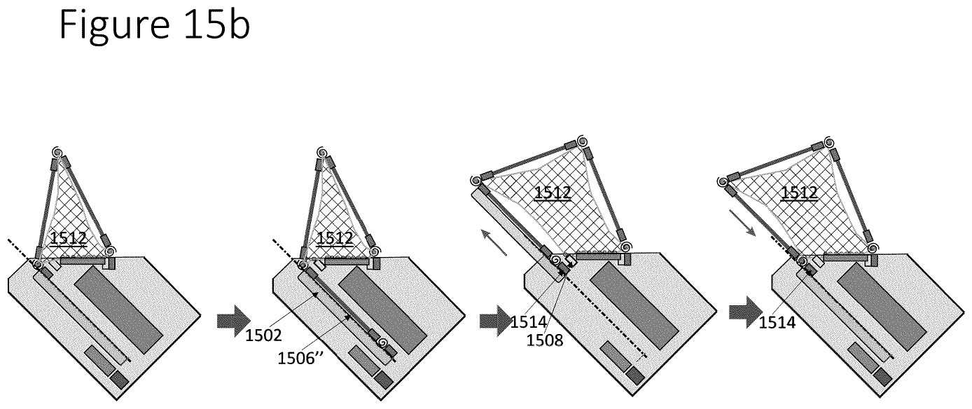

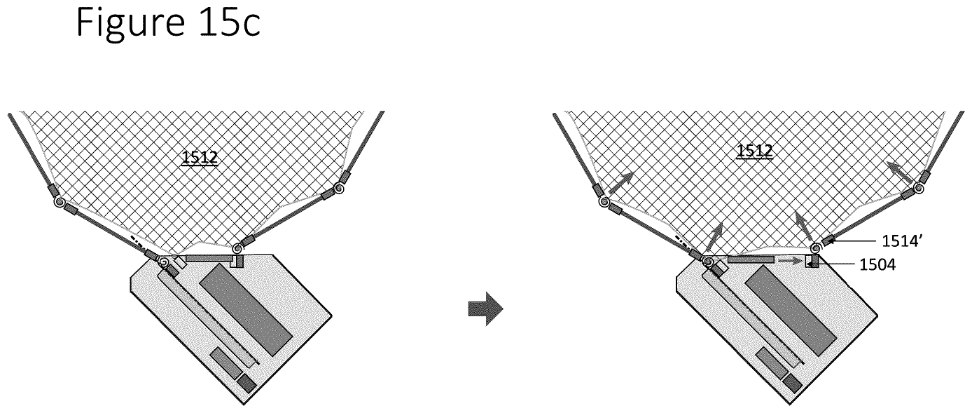

FIGS. 15A through 15C illustrate a reflector assembly operation with a tilted plate truss builder 1500 in accordance with some embodiments. In some embodiments, some bays 1502 are pre-built and coupled to the truss builder 1500; the first bay 1502′ is coupled to a truss support 1504 on the outside wall of the truss builder 1500, and the second bay 1502 is coupled to the assembly module 1506. The reflector assembly starts by deploying the two pre-built bays 1502, by translating the assembly module 1506. Once the pre-built bay 1502 has been pushed out, a net attachment device 1508 connects the node 1510 of the net 1512 to the truss joint 1514. The assembly module 1506 is retracted after releasing the pre-built bay 1506. When the bay 1502 deployment has been completed, the truss support 1504 on the opposite side of the assembly module 1506 is translated, bringing the first joint 1514′ closer to the assembly module 1506. The reduced distance between the first joint 1514′ and the assembly module 1506 reduces the tensions during the assembly. After completing bay deployment, the truss builder 1500 assembles subsequent bays and the rest of the reflector. For bay construction, the truss builder completes the following steps illustrated in FIG. 15B. First a manipulator picks up the joint and truss components from storage 1516 and constructs a new bay 1506″ on the assembly module 1502, then the constructed bay 1506″ is pushed out. The net attachment device 1508 connects the net 1512 to the truss joint 1514. The assembly module 1502 is retracted after the bay 1506″ has been released, to be ready for the next bay construction. The truss builder 1500 repeats this process until the last bay. After the truss builder finishes assembling all bays, a prestressing process is initiated as illustrated in FIG. 15C: the truss support 1504 translates back to the initial position with the first joint 1514′. The relocation of the first joint 1514′ stretches the cable net 1512, applying a prestress to the assembled reflector.

### Exemplary Data

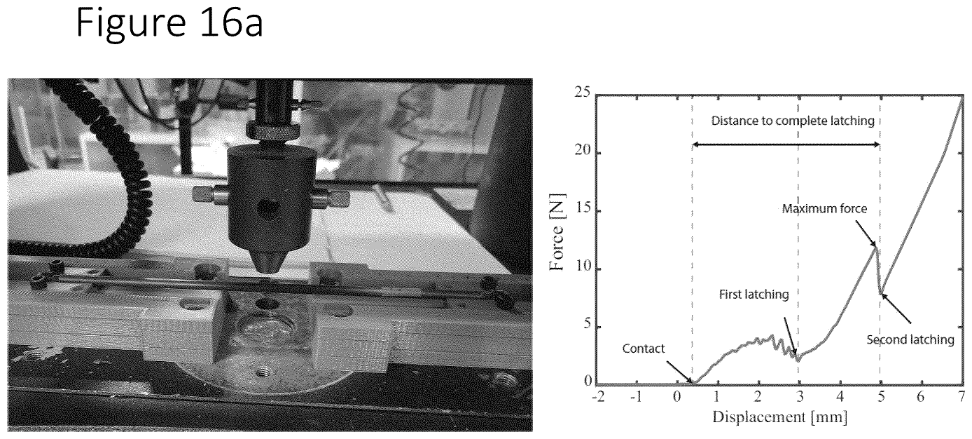

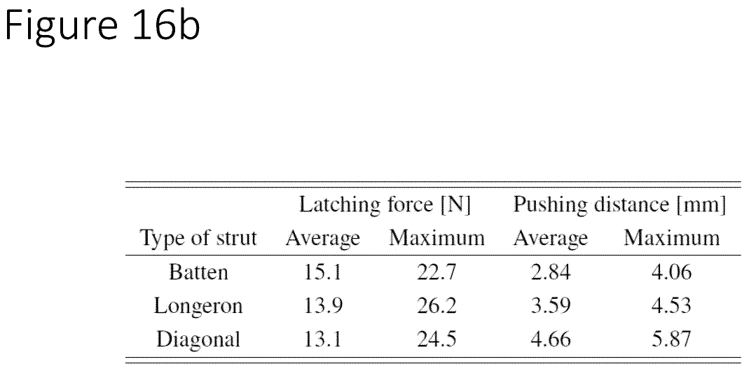

The strut (truss element) latching forces of an exemplary embodiment are depicted in FIGS. 16A and 16B. The strut latching forces were measured to determine the force needed for an actuator for the assembly sub-system that provides a sufficient pushing force. FIG. 16A shows the latching force measurement setup. As the assembly sub-system picks up the strut at the center, and then pushes it into the pre-placed joint, the latching force is measured with a testing machine that presses the center of a strut sitting on joint slots at both ends. Latching force measurements were collected for 45 struts (12 battens, 22 longerons, and 11 diagonals). FIG. 16A (right side) shows a representative force-displacement curve measured from the tests. In the force-displacement curve, two peaks appear as the strut is being pushed into the joint slots, which correspond to latching events on each joint slot. Based on the latching force measurement result, the maximum latching force was calculated as the maximum peak force before the second latching event. The push distance was the displacement of the tip from the first contact to the second latching. For each type of strut, the average and maximum latching force was calculated. FIG. 16B depicts the testing results and the average and maximum pushing distance. In the exemplary embodiment based on the latching force measurements, the requirement for the assembly sub-system push actuator needs to provide force higher than 40 N with a stroke of 9 mm, to achieve a safety factor higher than 1.5.

In many embodiments, the bay construction and release process and the switching of the joint position between the mounting plate and the transfer elements requires magnets and electromagnets for manipulation of the components and the truss bays. In many such embodiments switching the polarity of the electromagnets is a critical step and key step of the assembly process. As each electromagnet in the system attracts or repels the permanent magnets, the level of the magnetic force needed depends on the distance between an electromagnet and a permanent magnet. Therefore, in many embodiments, the gap distances between the magnets are carefully designed for all of the desired operations in the assembly process. Specifically, in many embodiments, the magnets and electromagnets are configured for the following conditions:
The manipulator can pick up the strut by overcoming the strut-holding force of the storage.
The strut should not be detached from the joint when the manipulator releases the strut.
Joints should not be detached from the mounting plate when the manipulator releases the strut.
The attraction of the transfer elements is stronger than the mounting plate when transferring the joint to the end fixture.
The attraction of the mounting plate should be stronger than that the end fixture when placing a joint on the mounting plate.

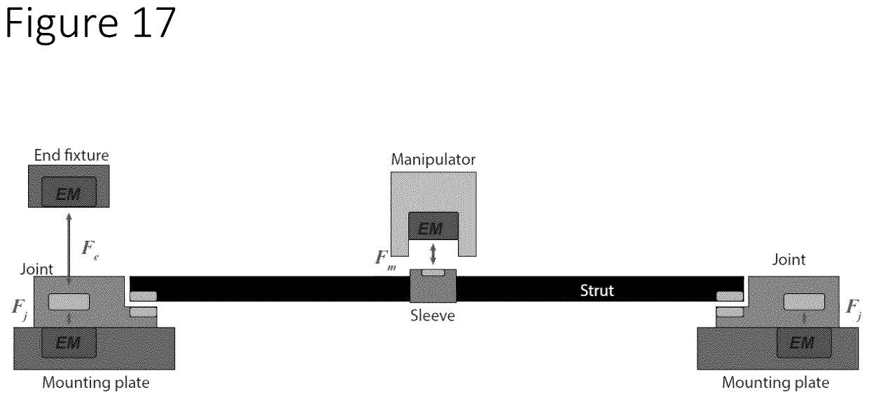

FIG. 17 shows a schematic drawing of the system and all the magnetic force interactions between electromagnets and the permanent magnet in accordance with some embodiments. In the drawing, Fm denotes the electromagnetic force between the manipulator and the magnet on the sleeve; Fe and Fj represent the electromagnetic forces of transfer element (joint-end fixture), and joint-mounting plate, respectively. Based on the conditions listed above, the following inequalities are established:

$${F}_{m +} > 2.1 N$$

$${F}_{m -} < 5.38 N$$

$${F}_{m -} < Min ( 2 {F}_{j +} , 2 {F}_{j +} - 2 {F}_{e -} )$$

$${F}_{j -} < {F}_{e +}$$

$${F}_{e -} < {F}_{j +}$$

The strut holding force from the storage and the attraction force between two permanent magnets in the strut endcap and strut receiving area were experimentally measured as 2.10 N and 2.69 N, respectively. The electromagnetic force can be expressed as a function of the voltage (V), and the distance (d) to the subject Fₑₘ=ƒ(d, V); the positive, and negative symbols in the subscript of the electromagnetic forces correspond to a maximum (+12 V applied) and minimum (−12 V applied) force generated from the electromagnet at given distance, respectively. To evaluate the stability of the system described, the safety factors for each step are defined based by inequalities:

$$S . F \text{.1} = \frac{{F}_{m +}}{2.1}$$

$$S . F \text{.2} = \frac{5.38}{{F}_{m -}}$$

$$S . F \text{.3} = \frac{2 Min ( {F}_{j +} , {F}_{j +} - {F}_{e -} )}{{F}_{m -}}$$

$$S . F \text{.4} = 1 + sgn ( {F}_{e +} - {F}_{j -} ) \frac{\vert {F}_{e +} - {F}_{j -} \vert}{\sqrt{2}}$$

$$S . F \text{.5} = 1 + sgn ( {F}_{j +} - {F}_{e -} ) \frac{\vert {F}_{j +} - {F}_{e -} \vert}{\sqrt{2}}$$

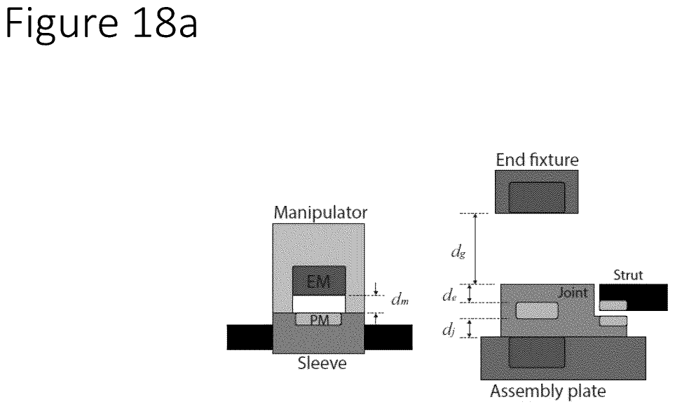

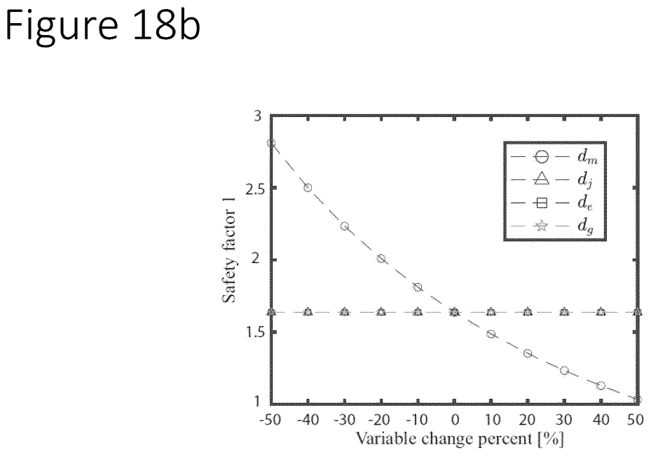

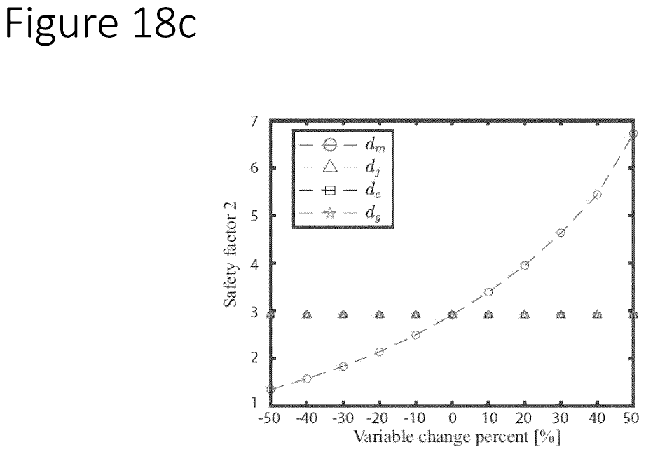

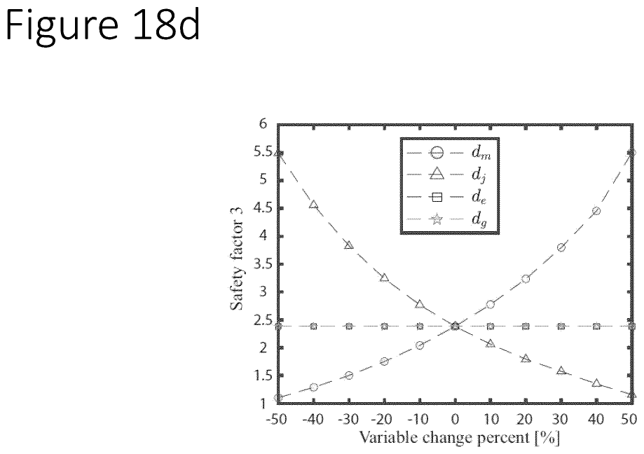

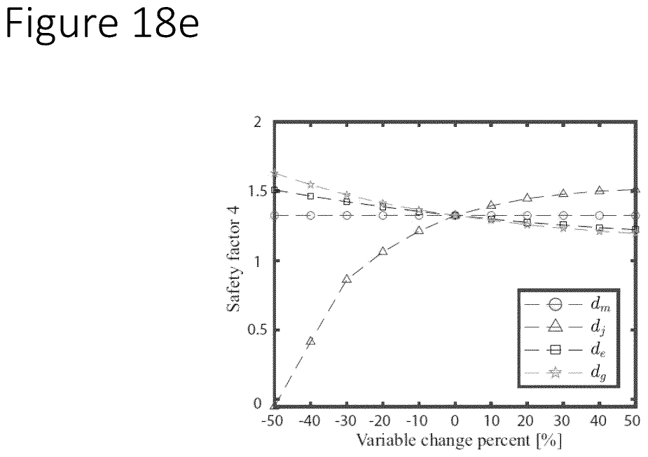

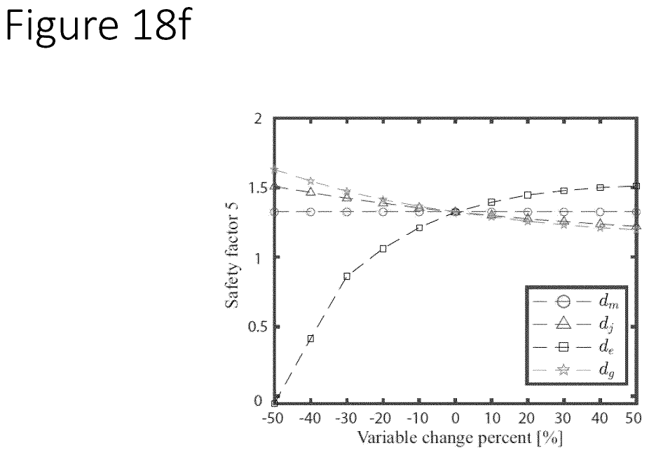

A safety factor below 1 means the corresponding part of the assembly process has failed. FIG. 18A depicts the variation of the design parameters of the system regarding the distance between electromagnets and permanent magnets: the gap between the manipulator and the sleeve is denoted by dm, while dj, de, and dg are the distance between the permanent magnet and mounting plate, joint top surface, and transfer element (end fixture), respectively.

To analyze the effect of the design parameters on the system operation, the variation of the force of the electromagnet with the distance to the permanent magnet was measured. Each safety factor was analyzed by varying design parameters, starting from a reference design point (dm=1.2 mm, dj=3.5 mm, de=3.5 mm, dg=3.5 mm) in the range −50% to +50%.

FIGS. 18B through 18F show the sensitivity analysis results for each safety factor. The results show the complicated inter-relations between the design parameters for each assembly process: Safety Factors 1 and 2 are affected only by dm showing opposite tendencies for varying dm. Safety factor 3 increases for increasing dm and decreasing dg. Safety Factors 4 and 5 are affected by dm and dg in a similar manner. However, de and dj show opposite tendencies against the joint transferring direction. It is essential to find the optimal value for the design parameters to complete all operations successfully.

To find the optimal design, the following objective function is defined:

$$f ( {d}_{m} , {d}_{j} , {d}_{e} , {d}_{g} ) = {( S . F \text{.1} - 1.5 )}^{2} + {( S . F \text{.2} - 1.5 )}^{2} + {( S . F \text{.3} - 1.5 )}^{2} + 5 {( S . F \text{.4} - 1.5 )}^{2} + 5 {( S . F \text{.5} - 1.5 )}^{2}$$

The optimal values for each design parameter are obtained by minimizing the established objective function. The result of the optimization is [dm, dj, de, dg]opt=1.0, 4.1, 4.2, 4.0 mm, which corresponds to safety factors [1.9, 2.3, 1.4, 1.5, 1.5].

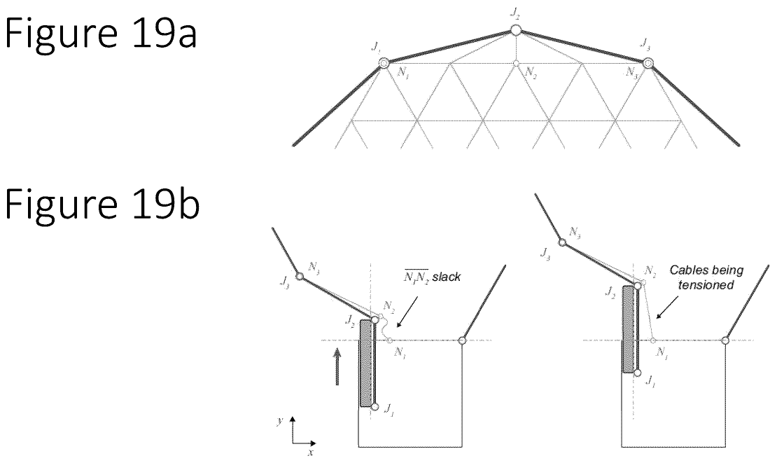

FIG. 19A illustrates a schematic of a corner of a reflector assembly and the geometry of the perimeter truss and the cable net in accordance with some embodiments. Three corner joints are denoted as J1 to J3, and the corresponding nodes on the cables are denoted as N1 to N3, respectively. As a result of the geometry of the reflector, the length of the cable nets connecting N1 to N3 is shorter than the length of the two longerons J1J2 and J2J3:

$$\overline{{J}_{1} {J}_{2}} + \overline{{J}_{2} {J}_{3}} > \overline{{N}_{1} {N}_{2}} + \overline{{N}_{2} {N}_{3}}$$

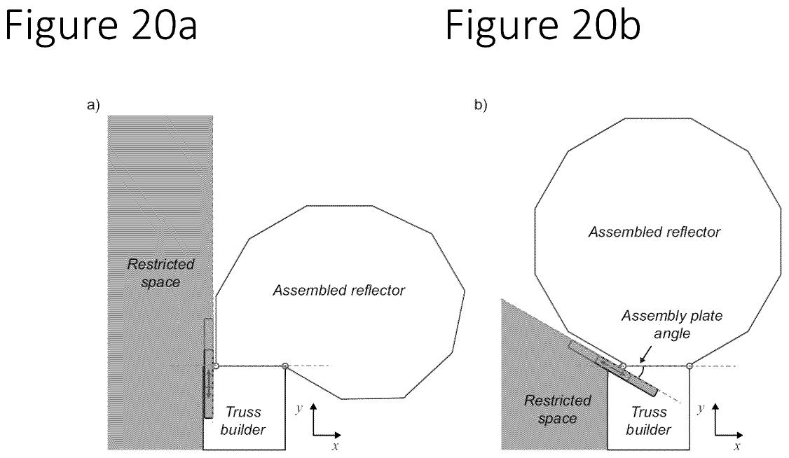

FIG. 19B shows the case when the constructed bay is being pushed out while the previously released bay stays behind the assembly module axis. The cable net node N1 is not yet connected to joint J1. The cable net node N1 is placed on a net attachment device, waiting for the bay to be fully pushed out. The cable N1N2 is slack, while the cable N2N3 is in tension. As the truss builder pushes the assembly module with the constructed bay mounted on it, the cable N1N2 becomes tensioned before the assembly module is fully pushed out. The tensioned cable has the potential to jam the assembly module or to break the cable when the truss builder forces out the assembly module. Therefore, the released bay, outside the truss builder, needs to not be kinked outward against the assembly module axis to prevent this undesirable circumstance. The space behind an assembly module, shown in gray in FIGS. 20A and 20B is a restricted area for the truss.

Another important parameter for truss builder design is the release orientation of the bay. FIG. 20A shows a schematic drawing of the assembled reflector during assembly when the truss builder is designed to release the constructed bay perpendicular to the truss support axis. As a result of the restricted area behind the assembly module, the configuration of the reflector is biased in the opposite direction to the assembly module. FIG. 20B is a schematic drawing of the assembled reflector by the truss builder with a tilted assembly module. By tilting the assembly module, more space is provided to the partially assembled reflector letting it be constructed in a more uniform and accurate shape.

The assembly module angle has an effect on the performance of the system; the distortion of the reflector shape can induce several issues in the assembly process: the distance between the joints in the assembled reflector becomes nonuniform, which increases the tension in the cable net. To stabilize the structure, the distorted reflector needs to be corrected to shape the desired configuration (i.e., a regular polygon) by rotating the reflector back from the biased configuration during assembly. Rotation during the assembly process induces a large change in the inertia properties of the system, which needs to be accounted for at a system level. It is essential to design the truss builder with optimal assembly module angle to reduce the level of shape distortion.

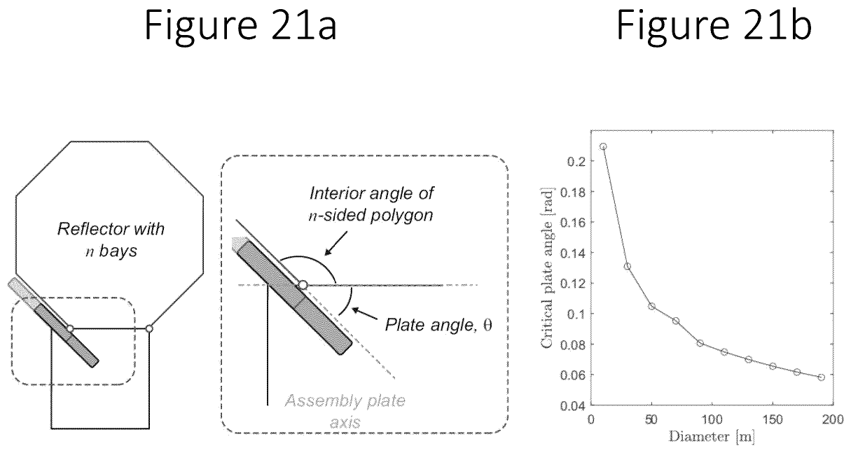

As the assembly module is tilted outward from perpendicular to the truss support axis, the shape distortion and bias during assembly decreases. FIG. 21A shows the relationship between the module angle and the interior angle of the assembled truss. The module angle is defined as the angle between the assembly module axis and the truss support axis. The reflector consists of n bays and forms a regular n-sided polygon in its completed configuration. The sum of the assembly module angle and the interior angle of the completed reflector is rr, when there is no distortion or bias in the reflector shape. The reflector shape becomes the right polygon once the last bay is released; this specific module angle is defined as the critical module angle, Ocr, and is calculated as:

$${θ}_{cr} = π - \frac{π ( n - 2 )}{n} = \frac{2 π}{n}$$

where n is the number of bays in the perimeter truss.

As the diameter of the reflector increases, the number of bays in the perimeter truss has to be increased to satisfy the reflector's precision requirement. Consequently, the critical module angle of the truss builder decreases. The critical module angle for different aperture diameters is plotted in FIG. 21B.

For the assembly and placement of the subsystem in many embodiments, several important subsystems (e.g., manipulator, net attachment devices, truss supports, etc.) are placed in the space between the assembly module axis and the truss support axis. The truss builder needs to be designed with a module angle larger than Ocr to provide enough space for the subsystems.

As the module angle of the truss builder is set to a value larger than Ocr, the reflector will experience shape distortion and bias during the assembly. As a result, the cable net will be subjected to tension even before the assembly process has been completed, and recovery from the biased shape will be required at the last step of the assembly.

The truss building process in many embodiments sequentially builds and releases the truss bays, and as a result, the system undergoes a variety of dynamic responses. For example, the center of mass changes, and the vibration is induced by bay release. In some embodiments, the module angle of the truss builder is larger than Ocr, and therefore, the reflector shape is distorted. Additionally, in some embodiments, the operation is disturbed by the tension from the cables during the reflector assembly. Each assembly step was thoroughly analyzed to ensure successful operation without anomalies.

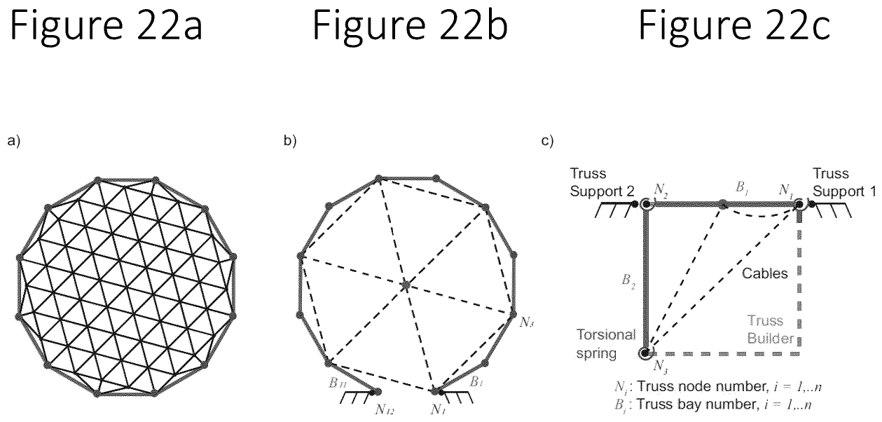

A low-fidelity finite element model was established for the structural elements. Each bay of the perimeter truss was modeled as a two-dimensional rod of the same length as the single bay, consisting of 10 beam elements. The boundary condition at the joint between two adjacent bays was pinned, allowing a relative rotational degree of freedom. A torsional spring was defined via rotation connector elements to provide stiffness (k=0.018 Nm/rad) at the joints. Angular velocity-proportional damping was applied at the joints, with joint masses modeled as equivalent point masses at each corresponding truss joint node, Ni. The original cable net configuration determined from the reflector geometry and surface error requirement was simplified during modeling for computational efficiency as illustrated in FIGS. 22A through 22C, and each cable was modeled via an axial connector element with a specified nonlinear penalty function for stiffness. The cable net was assumed to be flat, with point masses at intersecting nodes chosen such that mass-proportional damping is applied to the simulation. The analysis was restricted to two-dimensional motion and was performed with the Dynamic, Implicit integrator in Abaqus. The maximum numerical damping was applied (a=−0.33) on the integrator.

To simulate the step-by-step assembly process, the simulation steps were generated as repetitions of “rod translation”, “activating the cable net”, and “release of translated rod”, which correspond to “bay construction and push out”, “attaching cable net node”, and “dynamic response of intermediate polygonal truss”, respectively.

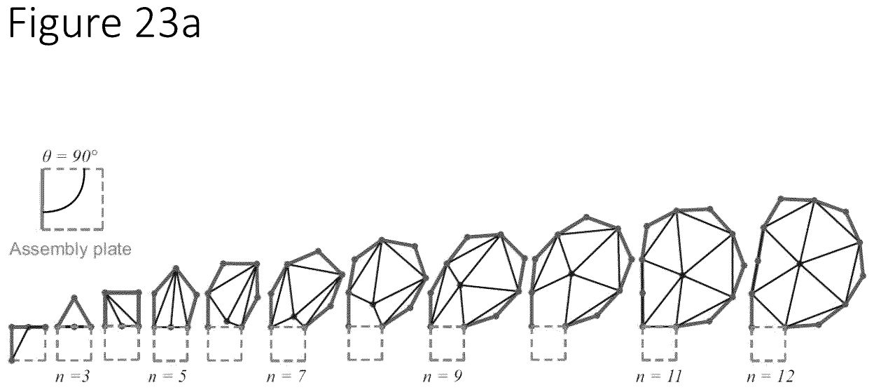

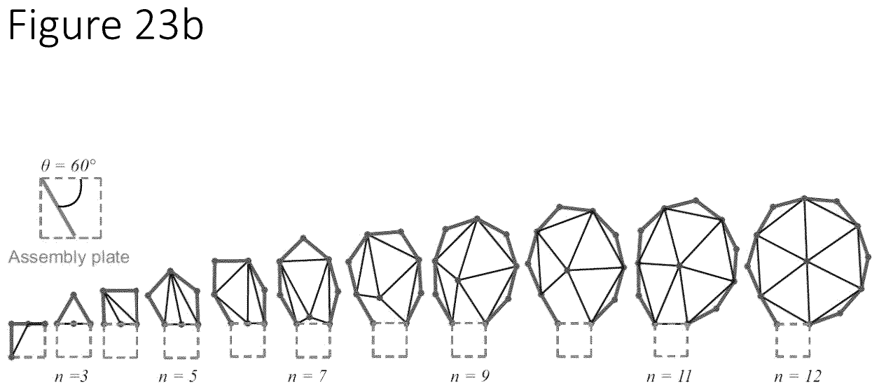

The angle at which the truss bays are pushed out poses a constraint on the range of motion of the structure during assembly. Depending on the angle, the structure becomes more or less distorted during assembly. The effect of the module angle was evaluated via numerical simulations for two different module angles, 0=90°, 60°. The preliminary results for a 12-bay structure (Ocr=) 30° consisting of only the major cables are shown in FIGS. 23A and 23B. The final shape of the reflector is distorted, and the center is biased to the right for larger module angles (0=) 90°; the structure does not recover the intended polygonal shape (dodecagon, in this case) at the completion of the assembly process. In the case of 0=60° module angle, the center of the assembled reflector is slightly biased to the right; however, the shape is almost correct to the desired polygonal shape. The simulation results indicate that smaller assembly module angles are preferred.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

1. A large space structure assembly device comprising:
an assembly structure configured to be deployed in space and proximal to a work volume, and having contained within the work volume an assembly module, an assembly sub-system, and having proximal to the work volume a plurality of joint elements, and a plurality of truss elements;
wherein the assembly-sub system, the plurality of joint elements, and the plurality of truss elements, are disposed in an assembly area within the work volume;
wherein the assembly module comprises a plurality of assembly coupling points and is configured to translate within a translation plane from a first position wherein a first portion of the assembly module having at least a first coupling point is located in the assembly area and a second position wherein a second portion of the assembly module is located outside of the work volume in a deployment area;
wherein the assembly sub-system further comprises a manipulator configured to translate and rotate within an assembly plane parallel to the translation plane and wherein the manipulator is configured to actuate perpendicular to the assembly plane and selectively couple with and transfer the joint elements and truss elements from a storage position to an assembly coupling point such that each joint element is coupled to the assembly module at an assembly coupling point and such that each truss element is interconnected between two joint elements; and
wherein the manipulator is configured to interconnect at least one truss element and at least one joint element on the assembly module to form a truss bay, and wherein the manipulator and assembly module are configured to operate together to sequentially form a plurality of truss bays wherein at least one joint of each adjacent truss bay pivotally couples two truss bays; and
wherein when a truss bay is assembled on the assembly module and the assembly module translates from the first position to the second position, any pivotally coupled truss bay disposed in the transfer area is moved into the deployment area.

2. The device of claim 1, further comprising a transfer element disposed in a transfer area and comprises a transfer coupling element that is disposed within a transfer plane.

3. The device of claim 2, wherein the assembly module further comprises a second portion having at least a second coupling such point that at the first position is located in the transfer area at the transfer plane, and at the second position, is located outside of the work volume.

4. The device of claim 2, wherein the first coupling point is located in the transfer area at the transfer plane at the second position.

5. The device of claim 2, wherein the transfer element is configured to selectively couple with the truss bay when the assembly module is located at the second position and transfer the truss bay off the assembly module to a transfer position and transfer the truss bay from the transfer position to the assembly module when the assembly module is located in the first position.

6. The device of claim 1, further comprising a storage sub-system configured to store at least one assembly component selected from the group consisting of the plurality of truss elements and the plurality of joint elements.

7. The device of claim 6, wherein the storage sub-system is configured to present each of the at least one assembly component to the manipulator.

8. The device of claim 1, wherein the plurality of pivotally coupled subsequent truss bays within the deployment area are configured as a configuration selected from the group consisting of perimeter truss structure, triangular truss structure, parallel truss structure, tubular structure, flat plate structure and scaffolding structure.

9. The device of claim 8, wherein a first end of the configuration is coupled to the structure.

10. The device of claim 1, further comprising a preassembled bay coupled to the structure at a first end.

11. The device of claim 1, wherein the structure is configured with a first configuration with a first volume for transportation and a second configuration with a second volume for operation.

12. The device of claim 1, wherein the transfer element is configured to selectively couple with the joint element and transfer the joint element from a first point on the assembly module to a second point on the assembly module.

13. The device of claim 1, wherein the transfer element comprises an electromagnet.

14. The device of claim 1, wherein each of the plurality of joint elements comprises a plurality of plates and a shaft wherein each plate is coupled to the shaft and configured to rotate about the shaft.

15. The device of claim 14, wherein each plate is further configured with a reception area configured with a geometry complementary to the truss element.

16. The device of claim 1, wherein at least one of the interconnected truss element and joint element further comprises an interconnecting element selected from the group consisting of a magnet, an electromagnet, a clamp, an actuator, a gripper, a latch, a compression fitting, and a compliment structure that couples and interconnects the truss element and the joint element.

17. The device of claim 1, wherein the joint element further comprises a spring element configured to provide rotational stiffness.

18. The device of claim 1, wherein each of the assembly coupling points further comprises an assembly point coupling element configured to selectively couple with the plurality of joint elements selected from the group consisting of a magnet, an electromagnet, a clamp, an actuator, a gripper, a latch, a compression fitting, and a compliment structure.

19. The device of claim 7, wherein the storage sub-system is configured to rotate to present a selected assembly component to the manipulator.

20. The device of claim 1, wherein the device further comprises an internal structure configured to couple to the plurality of joints.

21. The device of claim 20, wherein the internal structure is a net.

22. The device of claim 1, further comprising a cable coupled to the structure and a cable retraction device configured to tension the cable.

23. The device of claim 1, wherein each of the plurality of truss elements is configured to be stored in a first configuration and modified to a second configuration for operation.

24. A method of large space structure assembly comprising:
deploying a plurality of independent joint elements and a plurality of independent truss elements into space within an assembly satellite proximal to a work volume;
interconnecting at least one truss element through at least one joint element to form a truss bay within the work volume;
extending the truss bay outside of the work volume; and
repeating the interconnecting of truss elements and joint elements to sequentially form a plurality of truss bays, wherein each truss bay is interconnected to an adjacent truss bay such that a plurality of interconnected truss bays are formed and sequentially extended outside of the work volume as a single space structure.

25. The method of claim 24, wherein the interconnecting comprises:
positioning at least one joint element on an assembly module with a manipulator; and
coupling at least one truss element to the at least one joint element with the manipulator to form a truss bay.

26. The method of claim 25, wherein extending the interconnected truss bays outside of the work volume comprises:
sequentially transferring each of the plurality of truss bays from a first point on the assembly module to a transfer element when the assembly module is in the second position;
sequentially transferring each of the plurality of truss bays from the transfer element to a second point on the assembly module when the assembly module is in the first position; and
assembling the plurality of truss bays into a perimeter truss structure.

27. The method of claim 24, wherein assembling the truss bay further comprises coupling at least one truss element to a joint of a preassemble truss bay disposed within the work volume and coupled to the assembly satellite at a first end.

28. The method of claim 24, wherein the preassembled truss bay is coupled to the assembly satellite through a cable through a retraction device configured to retract the cable to keep a predefined tension thereon.

29. The method of claim 24, further comprising coupling an internal structure to each of the plurality of truss bays.

30. The method of claim 24, further comprising tensioning the perimeter truss structure with a set tension to manipulate the single space structure into an orientation.

31. The method of claim 24, wherein the joint elements and truss elements are configured to couple with magnets.

32. The method of claim 24, wherein the assembly module comprises an an assembly coupling element configured to selectively couple with the plurality of joints.

33. The method of claim 24, wherein the transfer element comprises a transfer coupling element configured to selectively couple with a truss bay.

34. The method of claim 24, wherein the manipulator comprises a manipulator coupling element configured to selectively couple with the plurality of joint elements and the plurality of truss elements.

35. A system for assembling large space structures comprising:
an assembly unit configured to be deployed in space and proximal to a work volume, and having disposed proximal to the work volume a plurality of individual and disconnected truss elements and a plurality of individual and disconnected joint elements;
wherein the assembly unit is configured to selectively interconnect the plurality of the individual and disconnected truss elements through the plurality of the individual and disconnected joints to form at least two interconnected truss bays, each truss bay being formed by at least one truss element and one joint element; and
wherein the assembly unit is further configured to extend the interconnected truss bays outside of the work volume as a single space structure.

36. The system of claim 35, wherein a disconnected internal structure is disposed proximal to the work volume, and the assembly unit is further configured to couple the internal structure to the interconnected truss elements so the internal structure spans the single space structure.

37. The system of claim 35, wherein the single space structure is configured as a reflector antenna.

38. The system of claim 36, wherein the assembly unit is further configured to apply a first tension to the internal structure to facilitate the extension of the interconnected truss elements.

39. The system of claim 38, wherein the assembly unit is further configured to apply a second tension to the internal structure and articulate the single space structure into a configuration.

40. The system of claim 35, wherein the assembly unit is further configured to extend the interconnected truss elements outside the work volume at a selected angle.

41. The system of claim 40, wherein the truss bays are configured with a plurality of geometries such that when the interconnected structure is extended, the single space structure forms a set configuration.

42. The system of claim 35, wherein the assembly unit is further configured to apply a force to the interconnected truss bays such that the interconnected truss bays outside the work volume translate to a selected orientation.

43. The system of claim 35, wherein the assembly unit is configured to be transported to space in a first configuration and, when deployed in space, articulate to a second configuration for operation.

44. The system of claim 35, wherein the assembly unit is configured to extend the interconnected truss elements outside the work volume sequentially as each is constructed.

45. The system of claim 35, wherein at least two of the interconnected truss elements are connected at one end to the assembly unit such that the assembly unit forms a section of the single space structure.
